(19) United States
(12) Patent Application Publication
(10) Pub. No.: US 2010/0290908 A1
(43) Pub. Date: Nov. 18, 2010

(54) A BLADE PITCH CONTROL MECHANISM

(75) Inventors: Tom DENNISS, New South Wales (AU); Bandu Ranjith Kumara OBEYESEKERA, Bella Vista (AU); TIMOTHY FINNIGAN, Surry Hills (AU); Raymond ALCORN, Kinsale, Cork (IE)

Correspondence Address: HARRITY & HARRITY, LLP, 11350 Random Hills Road, SUITE 600, FAIRFAX, VA, 22030, US

(73) Assignee: ENERGETECH AUSTRALIA PTY LIMITED, New South Wales (AU)

(21) Appl. No.: 11/995,620

(22) PCT Filed: Jul. 14, 2006
(86) PCT No.: PCT/AU2006/000996

§ 371 Date: Jun. 1, 2009

(30) Foreign Application Priority Data
Jul. 15, 2005 (AU) 2005903772

(51) Int. Cl. B64C 11/06

(52) U.S. Cl. 416/147

(57) ABSTRACT

This invention relates to a blade pitch control mechanism and in particular to a blade pitch control mechanism for a turbine. The invention has been developed primarily for controlling the pitch of a plurality of blades of a turbine in an ocean wave energy extracting system. According to one aspect of the present invention provides a blade pitch control mechanism (1) for a turbine rotor (3) in an ocean wave energy extracting system, the mechanism including a gear assembly (5) mountable to a hub (7) of the rotor (3) for engaging a plurality of blades (9) rotatably mounted to the hub (7). Driving means (11) is operatively connected to the gear assembly (5) for rotating the gear assembly about an axis of the rotor (3), such that the driving means (11) rotates the gear assembly (5) at substantially the same speed as the rotational speed of the rotor (3) to fix the position of the blades (9) relative to the hub (7). The driving means (11) selectively varies the rotational speed of the gear assembly (5) relative to the rotational speed of the rotor (3), inducing rotation of the blades (9) relative to the hub (7) by the gear assembly (5), thereby adjusting the pitch of the blades (9).

### FIELD OF THE INVENTION

The present invention relates to a blade pitch control mechanism and in particular to a blade pitch control mechanism for a turbine.

The invention has been developed primarily for controlling the pitch of a plurality of blades of a turbine in an ocean wave energy extracting system and will be described hereinafter with reference to this application.

### BACKGROUND OF THE INVENTION

Any discussion of the prior art throughout the specification should in no way be considered as an admission that such prior art is widely known or forms part of common general knowledge in the field.

Environmental concerns and the awareness of the finite resources of traditional combustible hydrocarbon fuel sources has lead to research into sustainable non-polluting energy sources such as waves, wind, tidal, geothermal and solar.

Numerous different types of wave power generation systems have been proposed. One system employs the basic principle of using the vertical motion inherent in the movement of waves to effect a rotary movement of turbine to drive directly or indirectly a generator to produce electricity. In such systems, there is frequently reversing air flow conditions present, caused by the oscillatory motion of the waves. A number of specially configured unidirectional turbines have been designed to allow the turbine to continue operating in response to such reversing air flow conditions. A commonly used turbine is known as the “Wells” turbine, which has a monoplane axial fan type structure with radially extending blades of an aerofoil section and are generally symmetrical about the chord line. The blades are fixed with their planes of zero lift normal to the axis of the rotor. However, these early turbines were known to suffer from stalling, often resulting in shut-down of the wave energy harnessing plant. This stalling occurred due to the fact that such a turbine needed to be designed around anticipated levels of air flow, whereas the size of the waves entering the turbine chamber cannot be controlled for all locations. Thus, when a larger sized wave enters the chamber, its momentum causes a correspondingly greater air flow rate through the turbine blades. As the rate of rotation of the blades is unable, with its static blade configuration, to increase correspondingly to counter this increased air flow, the angle of attack of the air flow to the blades increases beyond the stalling angle and the turbine shuts down.

In response to the problems in the prior art, including the above problem, the Applicant proposed a turbine in PCT Application No. PCT/AU97/00758, published as WO 98/21473, the entire disclosure of which is hereby incorporated by reference. The turbine included a rotor and a plurality of straight, radially extending air flow section blades connected to a central hub of the rotor. The approximately symmetrical shape of the blades and their orientation in relation to the hub facilitated unidirectional rotation of the rotor in response to reversing axial fluid flows therethrough.

The turbine proposed in the Applicant's above application included a blade pitch variation or reversal mechanism which was disposed on the hub to rotate each blade about a central spigot on which each blade was mounted to the hub. While this arrangement is effective for enabling the pitch of the blades to be varied to thereby optimise the angle of attack for fluid flow in both directions, the pitch blade reversal mechanism required additional components for the turbine. This adds to its weight, structural complexity and maintenance requirements, thereby increasing the risk of failure of the mechanism.

### OBJECT OF THE INVENTION

It is an object of the present invention to overcome or ameliorate at least one of the disadvantages of the prior art, or to provide a useful alternative.

It is an object of the present invention, in its preferred form, to provide a blade pitch control mechanism which is simple and compact in structure and relatively lightweight. Thus, the structural complexity, weight and maintenance requirements of the turbine are reduced, consequently lowering the risk of failure.

### SUMMARY OF THE INVENTION

Accordingly, one aspect of the present invention provides a blade pitch control mechanism for a turbine rotor in an ocean wave energy extracting system, said mechanism including:

a gear assembly mountable to a hub of said rotor for engaging a plurality of blades rotatably mounted to said hub, and

driving means operatively connected to said gear assembly for rotating said gear assembly about an axis of said rotor,

such that said driving means rotates said gear assembly at substantially the same speed as the rotational speed of said rotor to fix the position of said blades relative to said hub, and

said driving means selectively varies said rotational speed of said gear assembly relative to said rotational speed of said rotor, inducing rotation of said blades relative to said hub by said gear assembly, thereby adjusting the pitch of said blades.

Preferably, the drive means is fixedly connected to the gear assembly to directly rotate the gear assembly. The drive means is preferably a torque motor.

It is preferred that the gear assembly is a friction gear assembly. The gear assembly preferably includes a drive gear coupled to one or more pinion gears, the pinion gears being respectively connected to the blades. Preferably, the drive gear meshes with the pinion gears simultaneously to effect rotation of the blades. Preferably, the drive gear includes a disc, an annular plate or a circular plate. It is preferred that the friction gear assembly is a bevel gear assembly

Preferably, the driving means is rotatably mounted to a shaft of the rotor. It is preferred that the driving means is mounted to the rotor shaft by bearings. The rotor shaft is preferably connected to a generator.

The driving means preferably varies the rotational speed of the gear assembly within a range of 10% of the rotational speed of the rotor.

It is preferred that the driving means is operatively connected to a control unit. The control unit preferably controls the rotational speed of the gear assembly. Preferably, the control unit determines the amount of torque provided to the drive gear. It is preferred that the control unit is a programmable logic controller (PLC).

Another aspect of the invention provides a turbine including a blade pitch control mechanism as described above. A further aspect of the invention provides an ocean wave energy extracting system including a turbine having a blade pitch control mechanism as described above.

### BRIEF DESCRIPTION OF THE DRAWINGS

A preferred embodiment of the invention will now be described by way of example only with reference to the accompanying drawings, in which:

FIG. 1 is a partial perspective view of a turbine rotor with a blade pitch control mechanism according to the invention;

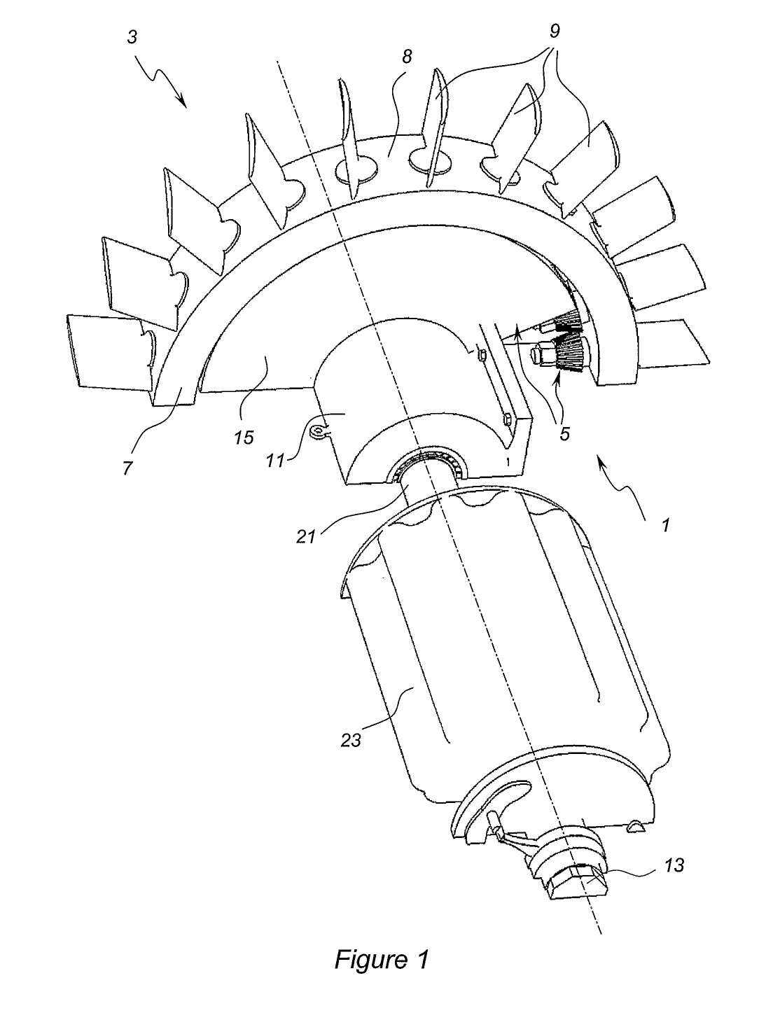

FIG. 2 is a perspective view of the rotor of FIG. 1;

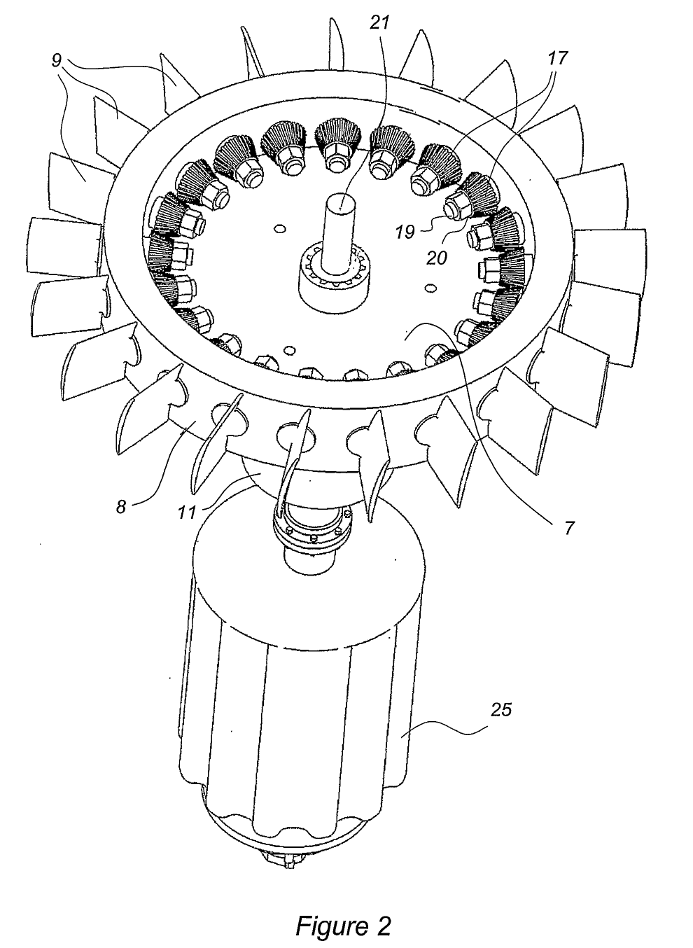

FIG. 3 is a cross-sectional view of the rotor of FIG. 1;

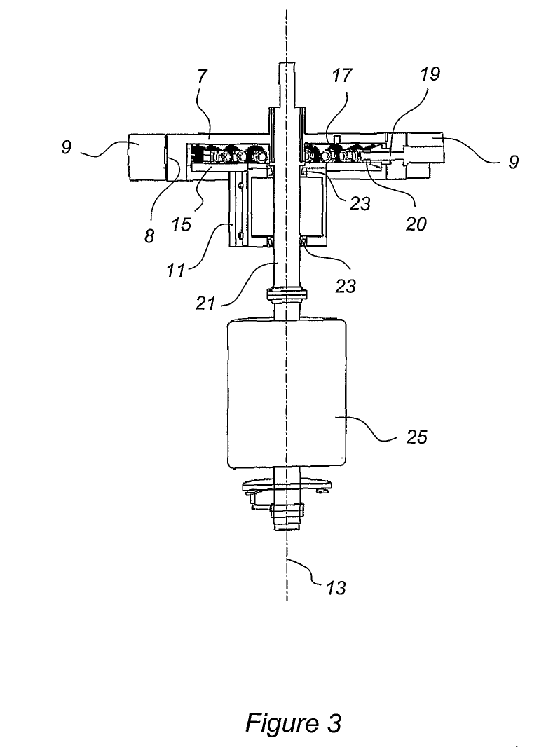

FIG. 4 is a cross-sectional perspective underside view of the rotor of FIG. 1; and

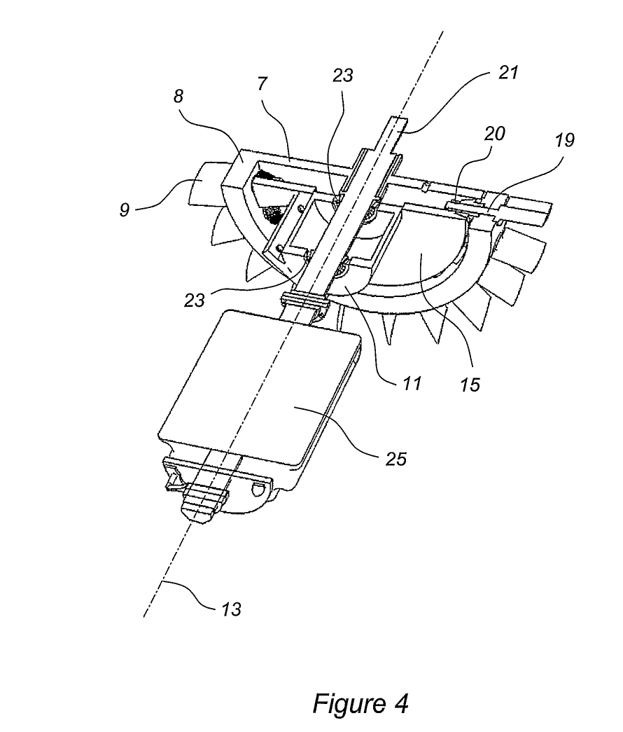

FIG. 5 is a cross-sectional perspective view of the hub of the rotor of FIG. 1.

### PREFERRED EMBODIMENT OF THE INVENTION

Referring to the drawings, a blade pitch control mechanism 1 for a turbine rotor 3 in an ocean wave energy extracting system includes a bevel gear assembly 5 mountable to a central hub 7 of the rotor 3 for engaging a plurality of aerofoiled sectional blades 9 rotatably mounted to the hub 7 at its outer circumferential rim 8. A brushless ring torque motor 11 is operatively connected to the friction gear assembly 5 for rotating the gear assembly about an axis 13 of the rotor 3. The torque motor 11 rotates the gear assembly 5 at the same speed as the rotational speed of the rotor 3 to fix the position of the blades 9 relative to the hub 7 and selectively varies the rotational speed of the gear assembly 5 relative to the rotational speed of the rotor 3. This induces rotation of the blades 9 relative to the hub 7 by the gear assembly 5, thereby adjusting the pitch of the blades 9.

The bevel gear assembly 5 includes a circular bevel plate 15 which engages a plurality of smaller bevel gears 17. Each gear 17 is connected to a blade 9 by its shaft 19 and a nut 20. The bevel plate 15 forms a drive gear freely rotatable about the rotor axis 13 and is rigidly connected to the torque motor 11. Thus, rotation of the bevel plate 15 about the rotor axis 13 rotates the bevel gears 17, which in turn rotates blades 9 to rotate about the hub 7. Rotation of the blades 9 relative to the hub 7 varies their pitch and thus their angle of attack.

The torque motor 11 is coaxially mounted to a rotor shaft 21 of the rotor 3 by two sets of bearings 23. This permits relative rotational motion to take place between the gear assembly 5 (including the torque motor 11 and bevel plate 15) and the rotor 3 (including the hub 7 and the rotor shaft 21) when the pitch of the blades 9 are adjusted. A typically small torque motor is used to provide a compact and lightweight design for the blade pitch control mechanism.

The torque motor 11 is electrically connected to a programmable logic controller (PLC) (not shown). The PLC controls the rotational speed of the torque motor 11 and can adjust the rotational speed in near real time. In this way, the PLC determines the amount of torque (and thus the rotational speed) which is delivered to the bevel plate 15. This enables variations in the torque to be introduced to the bevel plate 15 and achieve the desired relative motion of the blades 9 relative to the hub 7. Thus, more precise control of the pitch of the blades is achieved through the algorithms of the PLC controlling the torque motor 11.

The turbine rotor 3 is part of an ocean wave energy extracting system as described in WO 98/21473 and is connected to a generator 25 mounted adjacent one end of the rotor shaft 21. In the ocean wave energy extracting system, air is displaced by a reciprocating column of water oscillating within an air compression chamber. The displaced air travels through the turbine rotor 3, driving the plurality of blades 9 rotating the hub 7 and the rotor shaft 21. This rotation of the rotor 3 is converted to power by the generator 25.

As the rotor 3 begins to turn in response to the air flow, the PLC sends a signal the torque motor 11 to rotate the bevel plate 15 to synchronise its speed with the rotational speed of the rotor shaft 21 and the hub 7. This ensures that the pitch of the blades 9 is kept constant as the displaced air flow travels through the turbine rotor 3 to drive the rotor shaft 21.

When the air flow is reversed or there is a greater or lesser air flow rate through the blades 9, the pitch of the blades 9 needs to be adjusted to optimise the angle of attack of the blades 9 relative to the rotor axis 13. The PLC sends a signal to the torque motor 11 to either slightly increase or decrease its rotational speed and thus the rotional speed of the bevel plate 15 relative to the rotational speed of the rotor 3. This slight variance of up to 10% in the rotational speeds is transmitted as a rotational force by the bevel plate 15 to the bevel gears 17, which rotate, turning the blades 9 relative to the hub 7, adjusting their pitch accordingly. The increase or decrease in the rotational speed of the bevel plate 15 is only momentary, for only about a fraction of a second, and produces pitch variations of up to plus or minus 55°. Consequently, there is no substantial adverse effects to the efficiency of the rotor 3 in capturing the energy of the displaced air flow.

The invention in its preferred form thus provides a blade pitch control mechanism with a gear assembly which independently rotates about the rotor axis in unison with the hub and rotor, the hub and the gear assembly being connected through the rotatable blades. The torque motor 11 increases or decreases the rotational speed of the gear assembly relative to the rotational speed of the rotor 3 to adjust the pitch of the plurality of blades 9. Thus, the invention provides a simple and effective mechanism permitting dynamic control of the pitch of the blades.

The primary advantage of the invention in its preferred form is that the blade pitch control mechanism has a simplified gear assembly which reduces the complexity of the mechanical components of the turbine and the overall weight of the turbine. Since the blade pitch control mechanism has a fairly simple construction with less components than other complicated gear systems, wear and tear is minimised as well as the risk of failure. In its preferred form, the bevel plate shows no substantial fatigue over time.

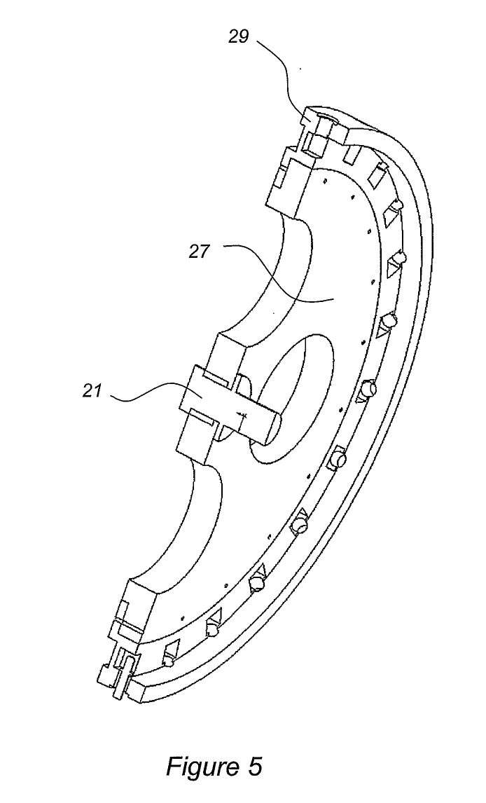

The invention in its preferred form also permits improvements in the turbine hub design. In particular, the simple structure of the blade pitch control mechanism facilitates the convenient installation and removal of the hub components. Thus, the components of the hub 7 can be replaced or inspected for maintenance and/or repair with relative ease. As shown in FIG. 5, the hub 7 can have a hub adaptor 27 fitted to the rotor shaft 21, to which is fitted a replaceable hub ring 29.

While the blade pitch control mechanism uses a bevel gear assembly in its preferred form, it will be appreciated by those skilled in the art that other gear assemblies, including other types of friction gear assemblies, can be used to achieve the same advantages of the invention.

Although the invention has been described with reference to a specific example, it will be appreciated by those skilled in the art that the invention may be embodied in many other forms.

1. A blade pitch control mechanism for a turbine rotor in an ocean wave energy extracting system, said mechanism including:
a gear assembly mounted to a hub of said rotor for engaging a plurality of blades rotatably mounted to said hub, and
drive means operatively connected to said gear assembly for rotating said gear assembly about an axis of said rotor,
such that said drive means rotates said gear assembly at substantially the same speed as the rotational speed of said rotor to fix the position of said blades relative to said hub, and
wherein said drive means selectively varies said rotational speed of said gear assembly relative to said rotational speed of said rotor, thereby inducing rotation of said blades relative to said hub by said gear assembly so as to adjust the pitch of said blades.

2. The blade pitch control mechanism for a turbine rotor in an ocean wave energy extracting system as claimed in claim 1 wherein said drive means is rotatbly mounted to a shaft of the rotor.

3. The blade pitch control mechanism for a turbine rotor in an ocean wave energy extracting system as claimed in claim 2 wherein said drive means is coaxially mounted to said shaft of the rotor.

4. The blade pitch control mechanism for a turbine rotor in an ocean wave energy extracting as claimed in claim 1 wherein said drive means is fixedly connected to the gear assembly to directly rotate the gear assembly.

5. The blade pitch control mechanism for a turbine rotor in an ocean wave energy extracting system as claimed in claim 1 wherein said drive means is a torque motor.

6. The blade pitch control mechanism for a turbine rotor in an ocean wave energy extracting system as claimed in claim 5 wherein the rotational speed of the torque motor is controlled by a programmable logic controller.

7. The blade pitch control mechanism for a turbine rotor in an ocean wave energy extracting system as claimed in claim 1 wherein said gear assembly is a friction gear assembly.

8. The blade pitch control mechanism for a turbine rotor in an ocean wave energy extracting system as claimed in claim 1 wherein said gear assembly includes a pinion gear connected to each blade and a drive gear coupled to said pinion gears wherein said drive gear meshes with said pinion gears to effect simultaneous rotation of the blades.

9. The blade pitch control mechanism for a turbine rotor in an ocean wave energy extracting system as claimed in claim 8 wherein said drive gear comprises a disc or plate.

10. The blade pitch control mechanism for a turbine rotor in an ocean wave energy extracting system as claimed in claim 9 wherein said drive gear is a bevel gear.

11. The blade pitch control mechanism for a turbine rotor in an ocean wave energy extracting system as claimed in claim 1 wherein said rotor is connected to a generator.

12. The blade pitch control mechanism for a turbine rotor in an ocean wave energy extracting system as claimed in claim 2 wherein said rotor shaft is connected to a generator.
